(19) United States
(12) Patent Application Publication
(10) Pub. No.: US 2012/0081406 A1
(43) Pub. Date: Apr. 5, 2012

(54) INTEGRATED BACKLIT FRONTLIGHT FOR REFLECTIVE DISPLAY ELEMENTS

(75) Inventors: Kebin Li, Fremont, CA (US); Ming-Hau Tung, San Francisco, CA (US); Evgeni P. Gousev, Saratoga, CA (US)

(73) Assignee: QUALCOMM MEMS Technologies, Inc., San Diego, CA (US)

(21) Appl. No.: 12/894,524

(22) Filed: Sep. 30, 2010

(51) Int. Cl. G02F 1/13357; G09F 13/08; G09G 5/10

(52) U.S. Cl. 345/690; 362/97.1; 362/97.2

(57) ABSTRACT

This disclosure provides systems, methods and apparatus, including reflective display elements that are illuminated using a light source that is situated behind the pixel elements. In one aspect, a back light guide is disposed behind the pixel elements and is configured to inject light through light-injection apertures between reflective pixel elements. The light travels through the light-injection apertures and into a front light guide. The front light guide comprises light turning features configured to turn the light propagating through the light-injection apertures so that the light is redirected onto the reflective pixel elements, thereby illuminating the reflective pixel elements.

### TECHNICAL FIELD

This disclosure relates to electromechanical systems and illumination systems for displays, including methods and apparatus for illuminating displays with reflective display elements.

### DESCRIPTION OF THE RELATED TECHNOLOGY

Electromechanical systems include devices having electrical and mechanical elements, actuators, transducers, sensors, optical components (e.g., minors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Reflected ambient light is used to form images in some display devices, such as those using pixels formed by interferometric modulators. The perceived brightness of these displays depends upon the amount of light that is reflected towards a viewer. In low ambient light conditions, light from an artificial light source is used to illuminate the reflective pixels, which then reflect the light towards a viewer to generate an image. New illumination devices are continually being developed to meet the needs of display devices, including reflective and transmissive displays.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display system. An array of reflective pixels is configured to display an image on a front side of the display system with an array of light-injection apertures interspersed between pixels of the array of pixels. A backlight is disposed behind the array of pixels. The backlight includes a back light guide and at least one light source coupled to the back light guide. The back light guide has a front side configured to eject light through the light-injection apertures and a back side opposite the front side of the back light guide. The front light guide includes a first plurality of light reflection features forward of the pixels. The first plurality of light reflection features are configured to reflect light ejected through the light-injection apertures towards the pixels. A second plurality of light reflection features can be provided spaced apart from and forward of the first plurality of light reflection features. The second plurality of light reflection features can be configured to reflect light ejected through the light-injection apertures or reflected off the pixels. The surfaces of the first and the second pluralities of light reflection features facing the reflective pixels can be reflective, while surfaces of the first and the second pluralities of light reflection features facing forwards can be visually black.

In another implementation, a display system is provided. The display system includes an image formation means for reflecting incident light outward from an image-displaying side of the display system to form a displayed image. The display system also includes an illumination means for generating light behind elements of the displayed image and directing the light forward of elements of the displayed image and redirecting the light back towards the image formation means.

In yet another implementation, a method for making a display device is provided. An array of reflective pixels having a front side for displaying an image is provided with pixels of the array of reflective pixels separated by light-injection apertures. A backlight is disposed on a back side of the reflective pixels, with the backlight configured to eject light through the light-injection apertures. A first plurality of light reflection features is provided forward of the pixels. The light reflection features are configured to reflect light, which has been ejected through the light-injection apertures, back towards the pixels.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3A shows an example of a diagram illustrating movable reflective layer position versus applied voltage for the interferometric modulator of FIG. 1.

FIG. 3B shows an example of a table illustrating various states of an interferometric modulator when various common and segment voltages are applied.

FIG. 4A shows an example of a diagram illustrating a frame of display data in the 3×3 interferometric modulator display of FIG. 2.

FIG. 4B shows an example of a timing diagram for common and segment signals that may be used to write the frame of display data illustrated in FIG. 4A.

FIG. 5A shows an example of a partial cross-section of the interferometric modulator display of FIG. 1.

FIGS. 5B-5E show examples of cross-sections of varying implementations of interferometric modulators.

FIG. 6 shows an example of a flow diagram illustrating a manufacturing process for an interferometric modulator.

FIGS. 7A-7E show examples of cross-sectional schematic illustrations of various stages in a method of making an interferometric modulator.

FIG. 8 shows an example of a cross section of a display system having an illumination system.

FIG. 9 shows another example of a display system having an illumination system.

FIG. 10 shows an example of a cross section of a display system having an illumination system.

FIG. 11 shows another example of a cross section of a display system having an illumination system.

FIG. 12 shows an example of a cross section of a front part of a display system having an illumination system.

FIGS. 13A-13D show cross-sections of examples of light reflection features.

FIGS. 14A and 14B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

Illumination systems for reflective displays, such as displays using interferometric modulators as pixels, typically include a light source (such as an LED, etc.) that is coupled into a light guide. Light propagates through the light guide and illuminates a display when it is ejected out of the light guide. For reflective displays, a light guide is often placed in “front” of the display; that is, on an image-displaying side of the display facing a viewer. As a result, the illumination system is typically called a front light. So that it does not block the display, the light source for the illumination system often injects light into the light guide from the side of the light guide.

Ideally, such a front light evenly and uniformly illuminates the display. However, uniformity is sometimes a concern. Scalability is also a concern. If light is injected into the light guide from the side, then as the display (and the front light) becomes larger, less light is available to illuminate pixels in the display that are far from the light source, due to light being extracted before it reaches that far away locations.

According to some implementations, a highly uniform illumination system is provided. One or more light sources are disposed in back of the pixels, opposite the display's front side. Light from the light sources is spread across a back light guide. The back light guide ejects the light from behind the pixels forward onto light reflection features disposed in front of the pixels. The light reflection features reflect the ejected light back onto the pixels of the reflective display. Thus, the reflective display is illuminated using light ejected from behind the pixels.

Particular implementations of the subject matter described in this disclosure can be implemented to realize one or more of the following potential advantages. In some implementations, the back light guide allows the use of multiple light sources, disposed at one or more sides of the light guide, behind the light guide, or a combination thereof, to achieve high uniformity and a desired level of brightness. In addition, because the back light guide is not seen, various light turning features and/or reflective layers can be applied to the back light guide to increase the uniformity of the light propagating through that light guide. It will be appreciated that the pixels illuminated by this light can be formed by interferometric modulators.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

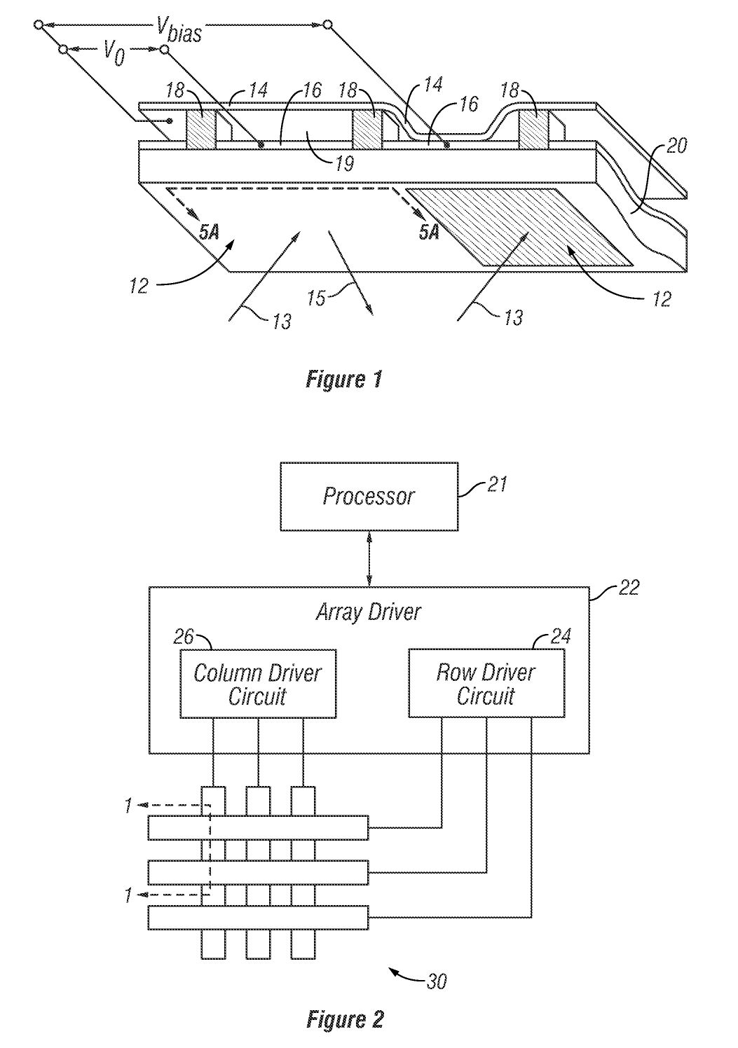

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

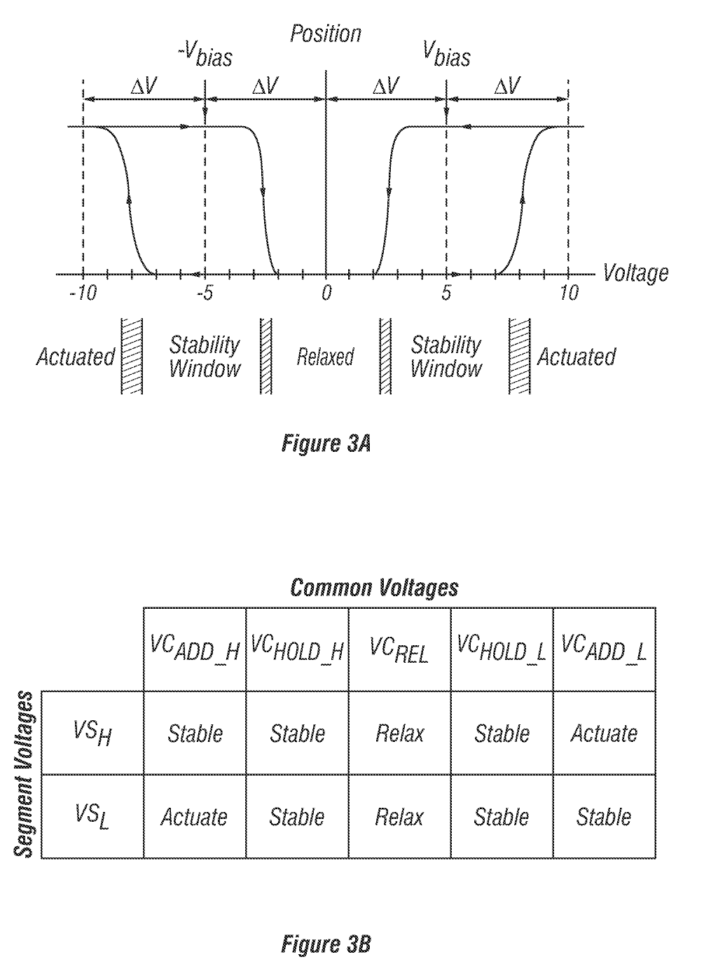

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

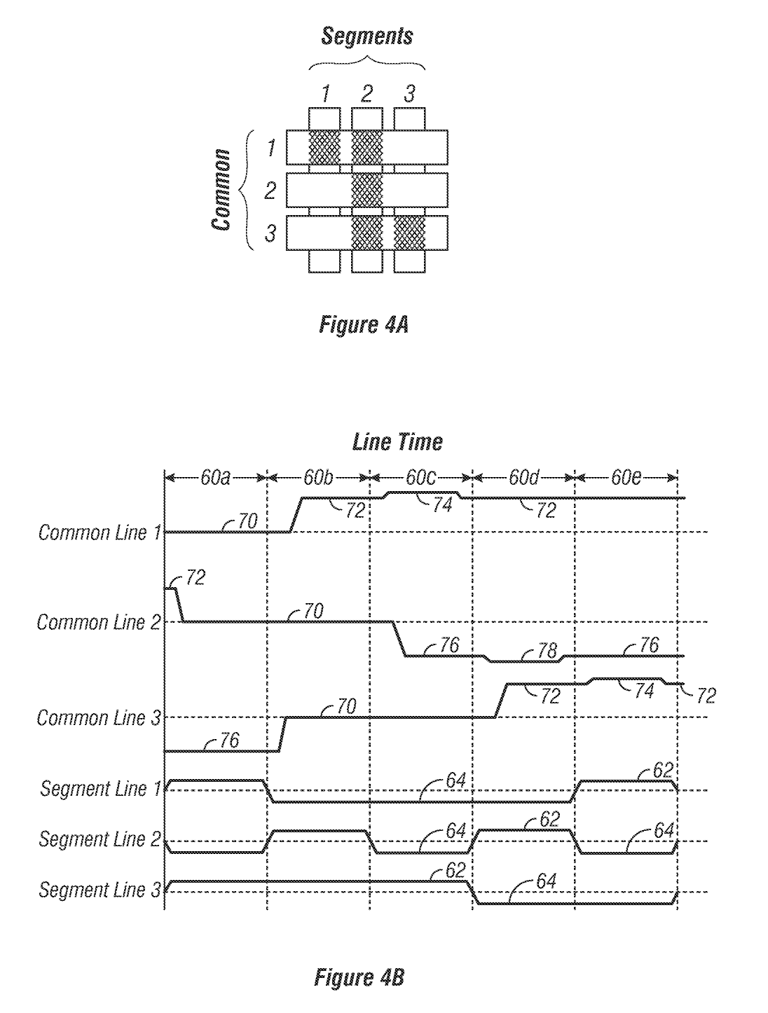

FIG. 3A shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3A. An interferometric modulator may require, for example, about a 10-volt potential difference to cause the movable reflective layer, or minor, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3A, exists where there is a window of applied voltage within which the device is stable in either the relaxed or actuated state. This is referred to herein as the “hysteresis window” or “stability window.” For a display array 30 having the hysteresis characteristics of FIG. 3A, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 3B shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

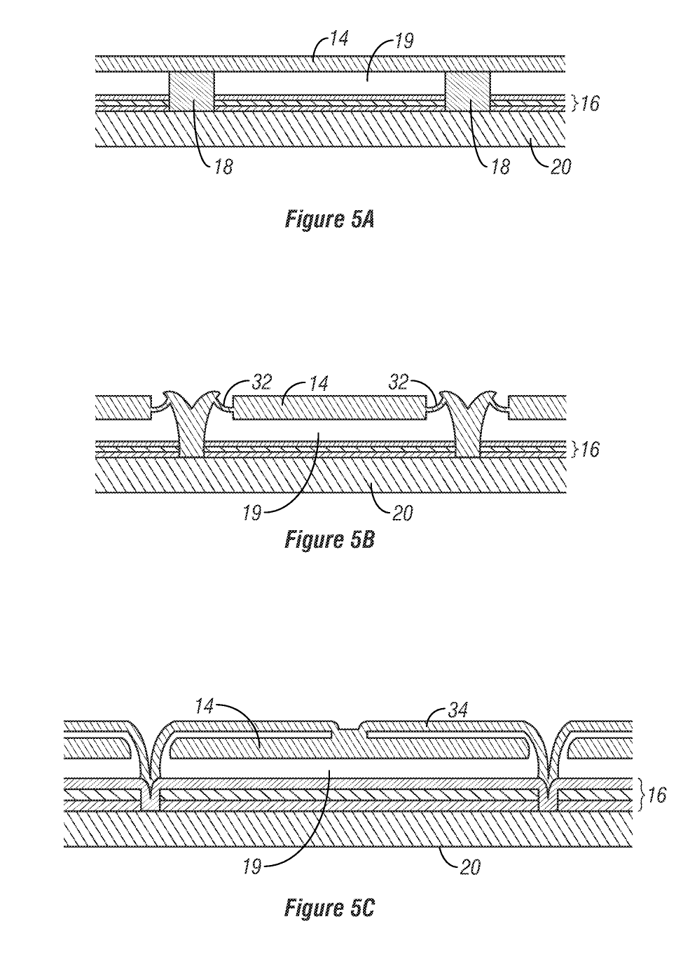

As illustrated in FIG. 3B (as well as in the timing diagram shown in FIG. 4B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3A, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 4A shows an example of a diagram illustrating a frame of display data in the 3×3 interferometric modulator display of FIG. 2. FIG. 4B shows an example of a timing diagram for common and segment signals that may be used to write the frame of display data illustrated in FIG. 4A. The signals can be applied to the, e.g., 3×3 array of FIG. 2, which will ultimately result in the line time 60e display arrangement illustrated in FIG. 4A. The actuated modulators in FIG. 4A are in a dark-state, i.e., where a substantial portion of the reflected light is outside of the visible spectrum so as to result in a dark appearance to, e.g., a viewer. Prior to writing the frame illustrated in FIG. 4A, the pixels can be in any state, but the write procedure illustrated in the timing diagram of FIG. 4B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 3B, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 4A, and will remain in that state as long as the hold voltages are applied along the common lines, regardless of variations in the segment voltage which may occur when modulators along other common lines (not shown) are being addressed.

In the timing diagram of FIG. 4B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 4B. In some other implementations, voltages applied along common lines or segment lines may vary to account for variations in the actuation and release voltages of different modulators, such as modulators of different colors.

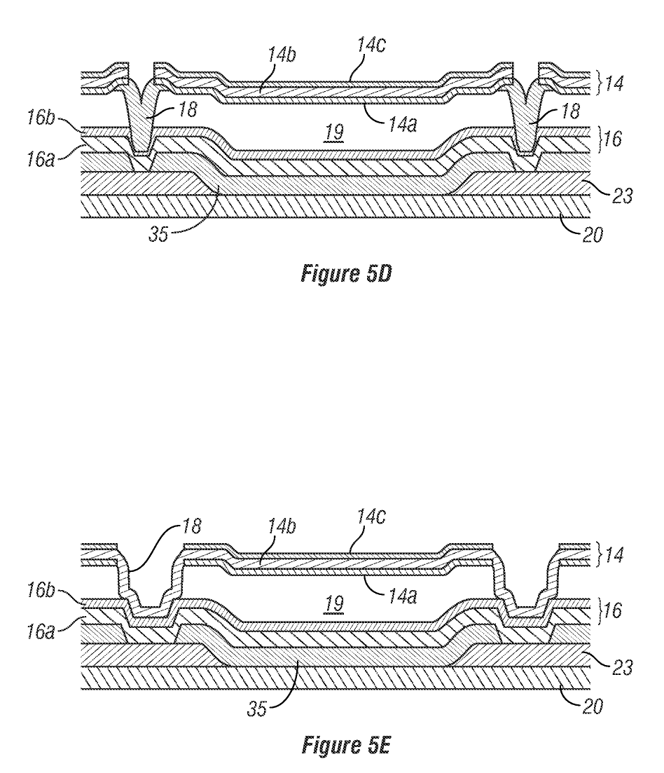

The details of the structure of interferometric modulators that operate in accordance with the principles set forth above may vary widely. For example, FIGS. 5A-5E show examples of cross-sections of varying implementations of interferometric modulators, including the movable reflective layer 14 and its supporting structures. FIG. 5A shows an example of a partial cross-section of the interferometric modulator display of FIG. 1, where a strip of metal material, i.e., the movable reflective layer 14 is deposited on supports 18 extending orthogonally from the substrate 20. In FIG. 5B, the movable reflective layer 14 of each IMOD is generally square or rectangular in shape and attached to supports at or near the corners, on tethers 32. In FIG. 5C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 5C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 5D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 5D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 5E shows another example of an IMOD, where the movable reflective layer 14 is self supporting. In contrast with FIG. 5D, the implementation of FIG. 5E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 5E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 5A-5E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 5C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 5A-5E can simplify processing, such as (e.g., patterning).

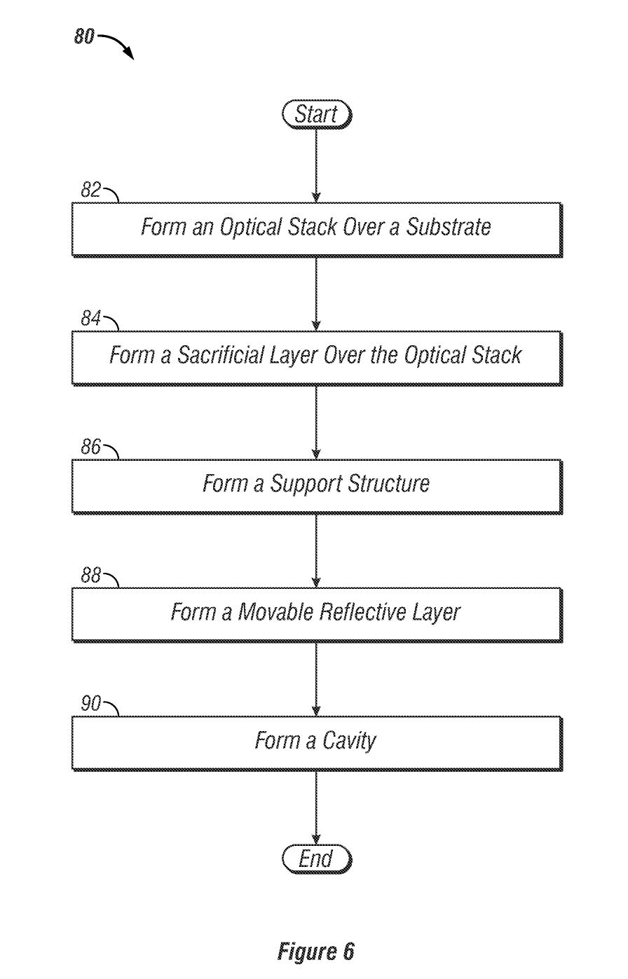

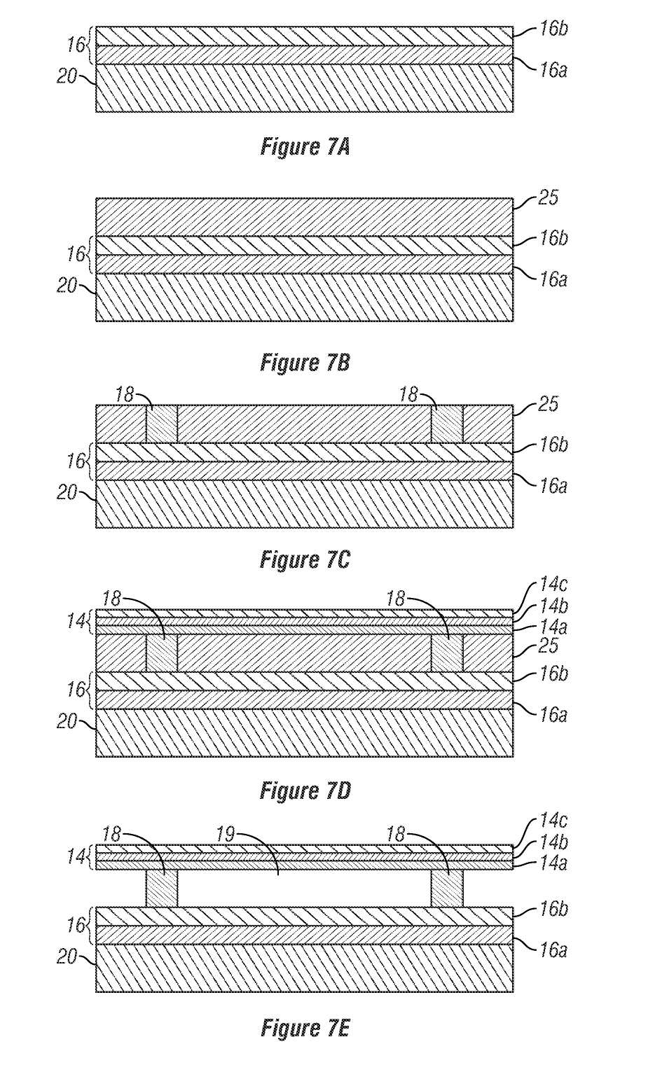

FIG. 6 shows an example of a flow diagram illustrating a manufacturing process 80 for an interferometric modulator, and FIGS. 7A-7E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 5, in addition to other blocks not shown in FIG. 6. With reference to FIGS. 1, 5 and 6, the process 80 begins at block 82 with the formation of the optical stack 16 over the substrate 20. FIG. 7A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 7A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 7B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 7E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 5 and 7C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 5A. Alternatively, as depicted in FIG. 7C, the aperture formed in the sacrificial layer 25 can extend through the sacrificial layer 25, but not through the optical stack 16. For example, FIG. 7E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 7C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 5 and 7D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 7D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 5 and 7E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

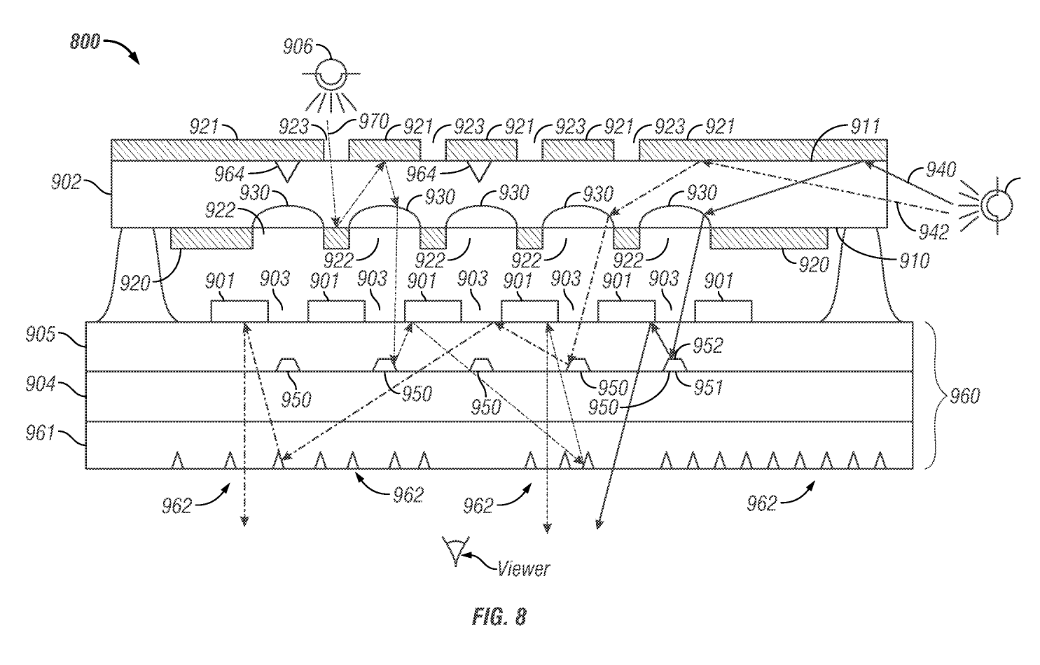

With reference to FIG. 8, an example of a cross-section of a display device 800 is illustrated. The display device 800 includes an array of reflective pixels 901 and a back light guide 902. The back light guide 902 is disposed behind the array of reflective pixels 901. The back light guide 902 has a front side 910 and a back side 911 opposite the front side. The front side 910 of the back light guide 902 faces the array of reflective pixels 901.

An array of light-injection apertures 903 is interspersed amongst the pixels 901. Some pixels of the array of reflective pixels 901 may be spaced apart from adjacent pixels to form the array of light-injection apertures 903. In some implementations, the reflective pixels 901 include various metallic and/or reflective layers, and hence, the reflective pixels 901 may not transmit appreciable amounts of light. For example, in some implementations, the reflective pixels 901 can be interferometric modulators, such as the interferometric modulators 12a, 12b (FIG. 1) described herein. In other non-limiting examples, the reflective pixels 901 may be electrophoretic display pixels, electrowetting display pixels, reflective LCD pixels, and super-twisted nematic display (STN) display pixels. The light-injection apertures 903 may be an optically-transmissive gap between the reflective pixels 901. For example, the apertures 903 may be an open space between the pixels 901, an optically-transmissive material, or a combination thereof. In some implementations, the light-injection apertures 903 include optically-transmissive structures, such as dielectric structures including posts, rails, or other border structures of the pixels 901.

With continued reference to FIG. 8, on a front side of the display 900, a substrate 904 may be disposed forward of the array of reflective pixels 901. The substrate 904 may include glass or other optically transparent material on which the array of reflective pixels 901 may be formed. In some implementations, the reflective pixels 901 may be formed directly on the substrate 904. However, in the implementation illustrated in FIG. 8, the reflective pixels are formed on a transparent buffer layer 905, which is formed on the substrate 904. The buffer layer 905 may be part of a black mask oxide layer, e.g., a layer supporting a black mask having parts that do not reflect light, as discussed herein. Therefore, it is understood that the reflective pixels 901 are formed over the substrate 904, even if there are intervening layers between them, such as the black mask oxide layer 905 shown in FIG. 8. In some other implementations, the substrate 904 may be disposed behind the pixels 901.

One or more light sources 906 may be coupled to and configured to inject light into the back light guide 902. The light sources 906 may be disposed at the sides of the back light guide 902, behind the back side 911, or a combination thereof. For example, one or more light sources can be disposed at the sides of the back light guide 902, and one or more additional light sources can be disposed behind the back side 911. The number and placement of light sources 906 may advantageously be selected to achieve desired uniformity and brightness levels.

In some implementations, the back light guide 902 is coated with reflective layers on one or both of the front side 910 and the back side 911. As illustrated, a reflective layer 920 coats the front side 910. The reflective layer 920 is patterned and has a plurality of openings 922, which allow light to be ejected out of the back light guide 902. In addition, a reflective layer 921 may also coat the back side 911. The reflective layer 921 may be patterned to have a plurality of openings 923, which allow light from a light source 906 to be injected into the back light guide 902.

The reflective layers 920, 921 aid in the propagation of light through the back light guide 902 by reflecting the light between the front side 910 and back side 911. It will be appreciated that one or both of the reflective layers 920, 921 may be omitted, so that light propagates through the light guide 902 by total internal reflection. However, because total internal reflection may not occur for all angles of incidence on the front and back sides 910, 911, use of the reflective layers 902, 921 may be advantageous to prevent light leakage and to increase the amount of light propagating through the light guide 902. Thus, as illustrated in FIG. 8, the back light guide 902 may be coated with patterned reflective layers 920, 921 on both the front 910 and back 911 sides of the back light guide 902. In addition, one or both of the reflective layers 920, 921 may be provided with light turning features 964 to help direct the propagation of light within the back light guide 902 and towards the lenses 930.

With continued reference to FIG. 8, the back light guide 902 may be provided with an array of lenses 930. The lenses 930 are shaped and located with respect to the light-injection apertures 903 so as to eject light out of the back light guide 902 and into the light-injection apertures 903. For example, the lenses 930 may have a convex shape (e.g., are curved or rounded inwards into the back light guide 902) or a concave shape (e.g., are curved or rounded outwards out of the back light guide 902). As illustrated, the lenses 930 are disposed on the front side of the back light guide 902, have a concave shape, and are filled with a high refractive index material, which refracts and directs light towards one of the light injection aperture 903.

As an example, in operation, light source 906 injects light ray 940 into the back light guide 902 from the side as illustrated in FIG. 8. Light ray 940 propagates through the back light guide 902 and may eventually be incident upon one of the lenses 930. The lens 930 redirects the ray 940 through a corresponding light-injection aperture 903.

Once light is redirected by one of the lenses 930 and passes through the light-injection apertures 903, the light is injected into a front light guide 960. The front light guide 960 may, in some implementations, include a first transparent buffer layer 905 forward of the pixels 901 and the substrate 904 forward of the first buffer layer 905. The first transparent buffer layer 905 includes a first plurality of spaced-apart light reflection features 950. The light reflection features 950 are shaped and positioned to turn light guided within the front light guide 960 towards the pixels 901, which may then reflect the light towards a viewer. Depending on the angle of incidence of light on the light reflection features 950, the light may be reflected so that it propagates through the front light guide 960 until it is reflected towards the pixels 901.

In some implementations, the front light guide 960 optionally also includes a second transparent buffer layer 961, which includes a second plurality of spaced-apart light reflection features 962. The light reflection features 962 are shaped and positioned to turn light guided within the front light guide 960 towards the pixels 901. The shapes, number and relative positions of the features 962 may be similar to, or different from that of the first plurality of light reflection features 950.

Returning to the example of the light ray 940, FIG. 8 shows the ray 940 being ejected out of the back light guide 902, passing through a light-injection aperture 903 and reflecting off of a light reflection feature 950 and totally-internally reflecting on a back side of the transparent buffer layer 905. The ray 940 eventually is turned by a turning feature 962 towards a reflective pixel 901. Thus, the pixels 901 may be illuminated with light ejected from the back light guide 902.

It will be appreciated that various layers 905, 904, 961 forming the light guide 960 may be formed of different materials, having different indices of refraction. In some implementations, the indices of refraction of the layers 905, 904, 961 are similar to prevent total internal reflection of light within a particular layer, or refraction between different layers.

It will also be appreciated that various modifications to the illustrated implementation may be made. Non-limiting examples of such modifications are discussed below.

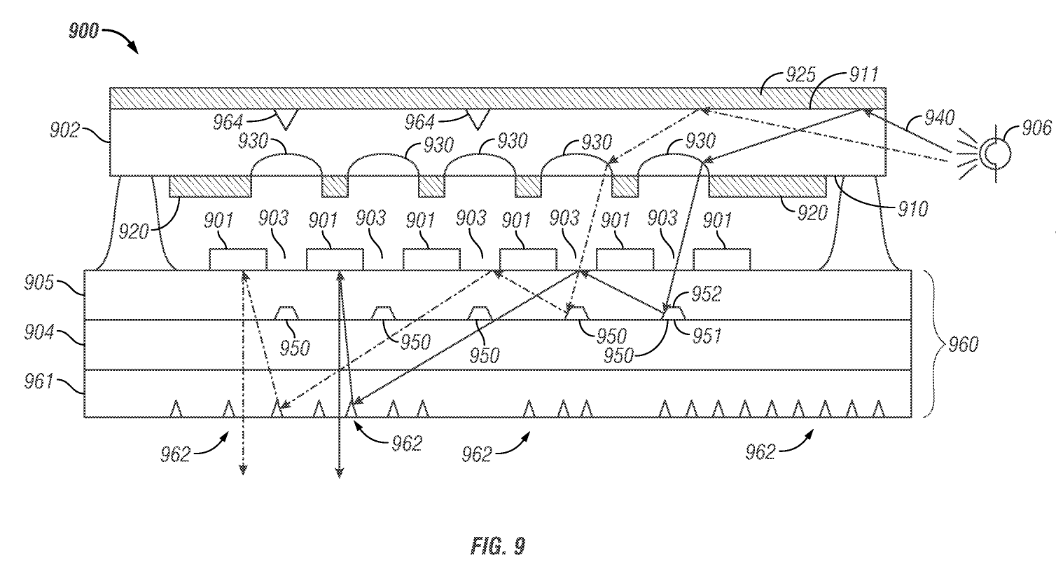

With reference to FIG. 9, an example of a cross-section of a display system 900 is shown. The reflective layer on the back side 911 may be a continuous blanket layer in some cases. As illustrated, a reflective layer 925 may extend without any openings across the back side 911. Such an arrangement may be particularly advantageous when the light sources 906 are disposed solely at the sides of the back light guide 902.

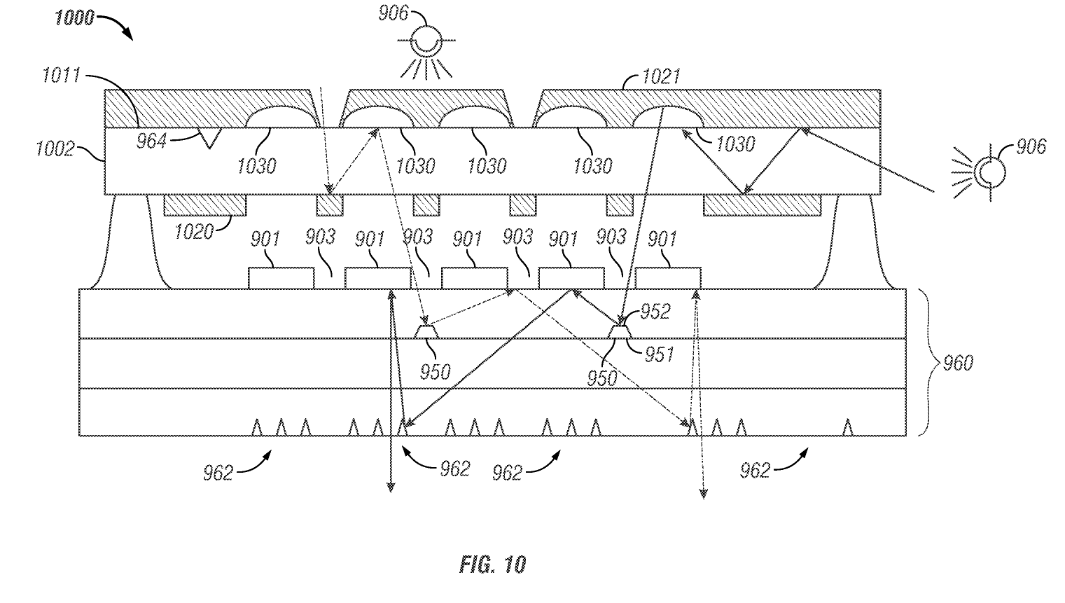

FIG. 10 shows an example of a cross-section of a display 1000 generally similar to the display 800 of FIG. 8. In the display 900, a back light guide 1002 is provided with lenses 1030 that are formed on the back side 1011 of back light guide 1002. The lenses 1030 are shaped and located with respect to the light-injection apertures 903 to eject light out of the back light guide 902 and into those apertures 903. In some implementations, the lenses 1030 have a convex shape (e.g., are curved or rounded inwards relative to the back light guide 902) or a concave shape (e.g., are curved or rounded outwards relative to the back light guide 902). The lenses 1030 may be an opening filled with gas or a transparent, solid material, e.g., the material of the back light guide 1002, or another material other than the material of back light guide 1002. The refractive index of the material filling the opening may be selected to focus light through the apertures 903. In some implementations, the back light guide 1002 is covered with reflective layers 1020, 1021 on a front and back side of the back light guide 1002. In such cases, the reflective layer 1021, in combination with the shape of the opening of the lenses 1030, may be used to focus light through the apertures 903.

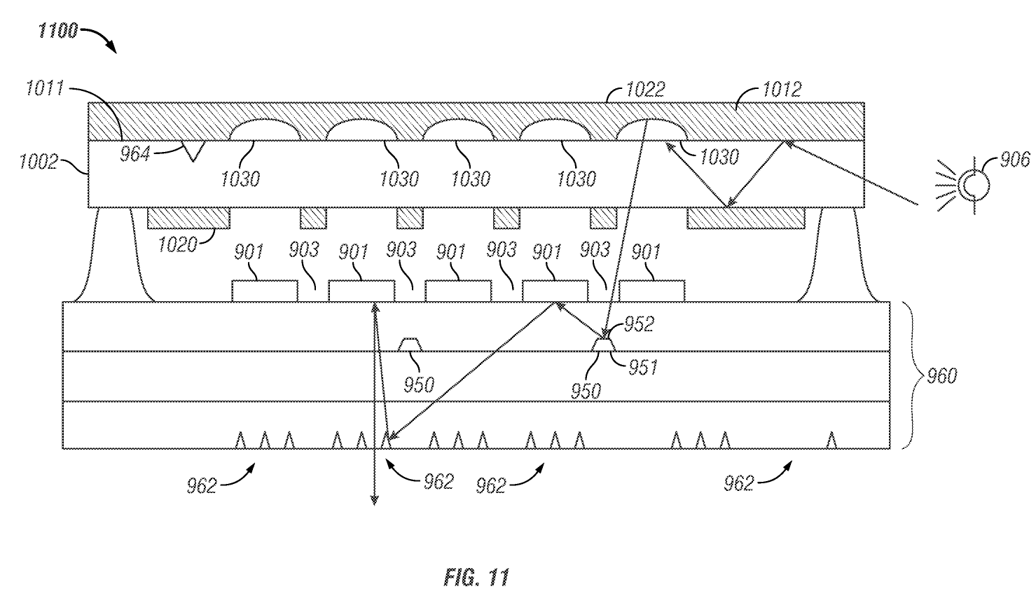

As illustrated, light may be injected by light sources 906 into the back light guide 1002 from the side of the light guide 1002, the back of the light guide 1002, or a combination thereof. In some other implementations, light is injected into the light guide 1002 only from the sides. FIG. 11 shows another example of a cross section of a display system having an illumination system. In such implementations, a reflective layer 1021 on the back side of the light guide 1002 may be a continuous blanket layer, without any openings.

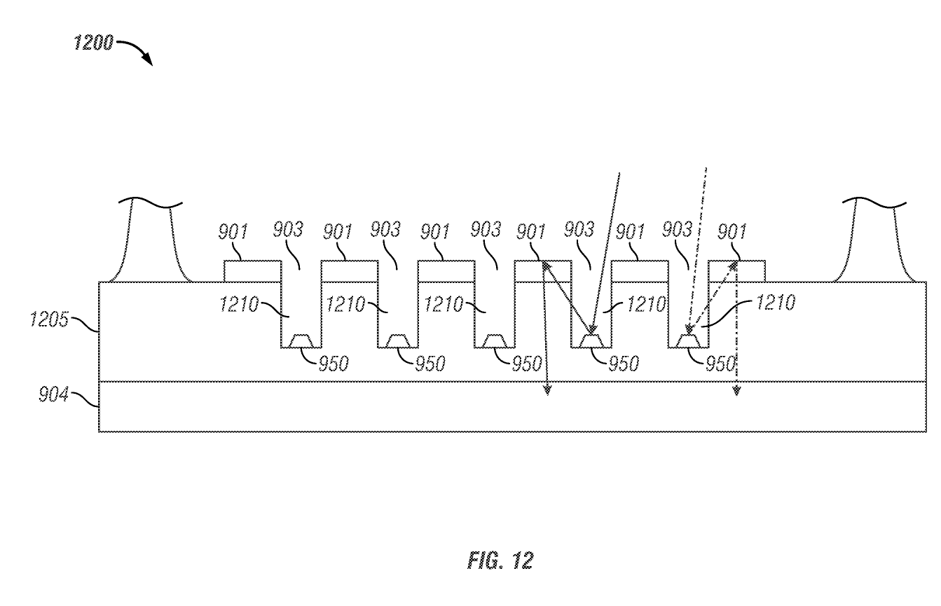

With reference to FIG. 12, a front part of a display 1200 is illustrated. The display 1200 includes the substrate 904 and a transparent buffer layer 1205. To improve the efficiency of the transmission of light from a back light guide (not shown) through the light-injection apertures 903 and to the first plurality of spaced-apart light reflection features 950, the buffer layer 1205 may be provided with a plurality of tunnels 1210. Each tunnel 1210 opens to a light-injection aperture 903 and extends to a light reflection feature 950. The tunnels 1210 provide an unobstructed path from the light-injection aperture 903 to the light reflection features 950, thereby allowing a high efficiency for light transmission to the light reflection features 950.

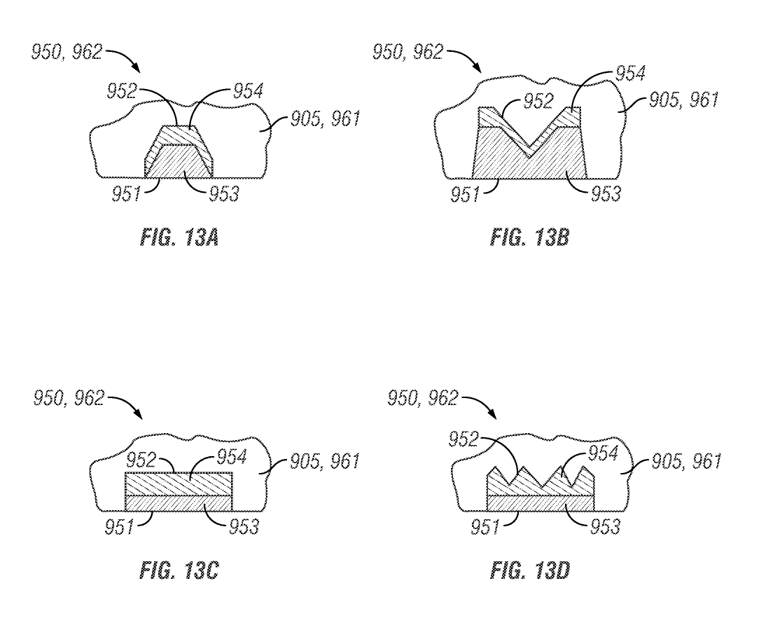

With reference to FIGS. 13a-13d, non-limiting cross-sectional views of examples of shapes for the light reflection features 950, 962 (FIGS. 8-12) are provided. With reference to FIG. 13a, in some implementations, the features 950, 962 are formed by a shaping material 953, which gives the desired shape to the features 950, 962. The material 953 is formed extending into the transparent buffer layers 905, 961. The material 953 may be in the shape of a protrusion into the layers 905 or 962, and have sloped, flat side surfaces extending towards a common plateau, which may also be flat. In other implementations, the side surfaces and/or the plateau surfaces are curved or rounded. The shape made out by the material 953 may be referred to a cap shape. Where the material 953 is not reflective, a reflective layer 954 may be overlaid that material. In some arrangements, the material 953 itself may be reflective and the layer 954 may be omitted.

With reference to FIG. 13b, in some implementations, the features 950, 962 have a so-called dent shape. The material 953 defines a shape having sloped sidewalls extending into the buffer layers 905, 961 towards a common point, then the surfaces of the shape dip downwards, forming a central cavity. The various surfaces of the shape may be flat, or rounded. The material 953 may be reflective, or where the material forming the protrusion 953 is not reflective, a reflective layer 954 may be overlaid the protrusion 953.

With reference to FIG. 13c, the light reflection features 950, 962 may be parts of a flat, patterned reflective layer 954. The reflective layer 954 may be formed with the material on a front side 951 of the features 950, 962. With reference to FIG. 13d, the flat, patterned reflective layer 954 may be roughened to diffuse light when reflecting it.

In some implementations, the light reflection features 950, 962 may include a black mask 953 that appears black and is non-reflective when viewed from the front side 951 of the light reflection features. Advantageously, the black mask 953 can minimize glare and artifacts that may be seen by a viewer looking at the front side of the display containing the light reflection features 950, 962. The black mask 953 may be formed of various visually black materials, including, without limitation, polymers, metals, metals oxides, or combinations thereof.

In view of the disclosure herein, it will be appreciated that the displays disclosed herein can be fabricated by various methods known in the art. For example, various deposition, patterning, etch and attachment steps can be applied to form the various layers, pixels, and light turning features of the displays. In some implementations, the front light guide 960 and the back light guide 902, 1002 may be separately formed and provided, and subsequently attached to one another.

To form the light guide 960, the substrate 904 may function as a base, around which the various other layers and features of the front light guide 960 may be formed. For example, the first buffer layer 905 may be formed with the first plurality of light reflection features 950 on a back of the substrate 904 and the second buffer layer 961 may be formed with the second plurality of light reflection features 962 on a front of the substrate 904. In some other implementations, the first and second buffer layers may both be formed on the same side of the substrate 904. In another implementation, only one of the buffer layers 905, 961 is formed, either on a front side or a back side of the substrate 904. In some implementations, the pixels 901 are formed in the back side of the substrate 904 so that the substrate 904 may act as a protective barrier against the external ambient environment. In other implementations, the pixels may be formed on a front side of the substrate 904 and another layer of material may be provided for use as a protective barrier.

To form the back light guide 902, 1002 an optically transparent piece of material may be provided. The piece of material may be machined or etched to form the lenses 930. Alternatively, where the lenses 930 extend outward from the light guide 902, 1002 the lenses may be separately formed and attached to the light guide 902, 1002. The reflective layers 920, 921 1020, 1021 may be deposited on the back and/or front sides of the 902, 1002 as desired and subsequently patterned to form openings in those layers.

The front light guide 960 and the back light guide 902, 1002 may be attached together by various methods. For example, the attachment may be accomplished using an adhesive, e.g., an epoxy, which bridges the front light guide 960 and the back light guide 902, 1002. In another example, the front light guide 960 and the back light guide 902, 1002 are mechanically secured to one another, e.g., by screws or other mechanical device or pressure.

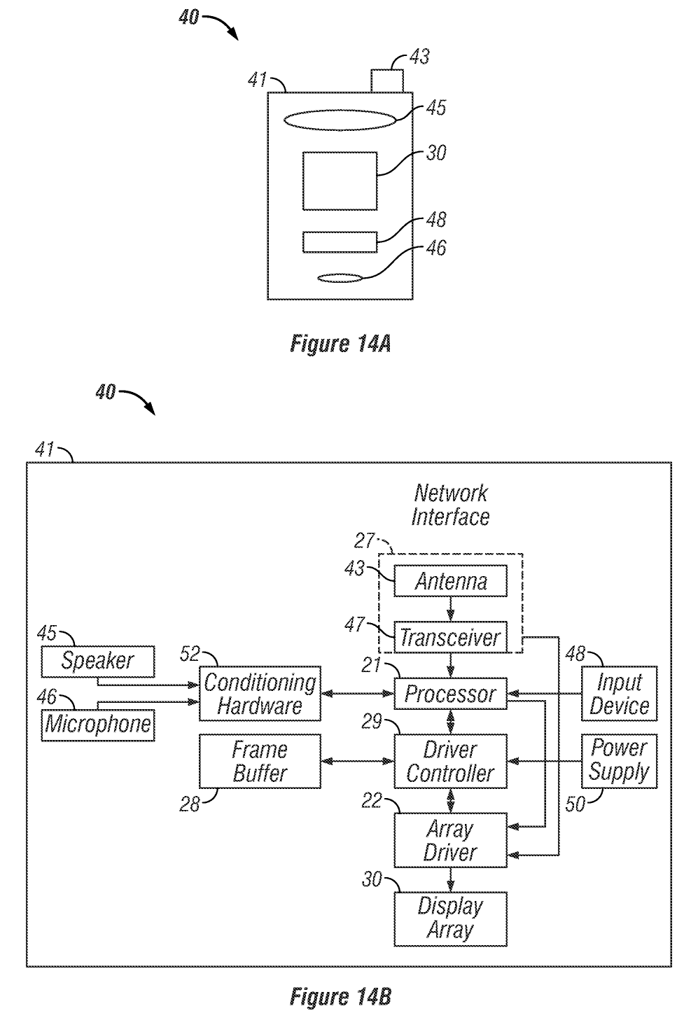

FIGS. 14A and 14B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display system, comprising:
an array of reflective pixels configured to display an image on a front side of the display system;
an array of light-injection apertures interspersed between pixels of the array of pixels;
a backlight disposed behind the array of pixels, the backlight comprising:
a back light guide;
at least one light source coupled to the back light guide,
wherein the back light guide has a front side configured to eject light through the light-injection apertures and a back side opposite the front side of the back light guide, and
a front light guide comprising a first plurality of light reflection features forward of the pixels, the first plurality of light reflection features configured to reflect light ejected through the light-injection apertures towards the pixels.

2. The system of claim 1, wherein at least some of the first plurality of light reflection features have a flat reflective surface facing the pixels.

3. The system of claim 1, wherein at least some of the first plurality of light reflection features have a roughened reflective surface facing the pixels.

4. The system of claim 1, wherein at least some of the first plurality of light reflection features have one or more angled surfaces configured to reflect light towards the pixels.

5. The system of claim 4, wherein the angled surfaces form a cap shape.

6. The system of claim 4, wherein the angled surfaces form a dent shape.

7. The system of claim 1, further comprising a second plurality of light reflection features spaced apart from and forward of the first plurality of light reflection features, the second plurality of light reflection features configured to reflect light ejected through the light-injection apertures or reflected off the pixels.

8. The system of claim 7, wherein the second plurality of light reflection features comprises one or more angled surfaces configured to reflect light towards the pixels.

9. The system of claim 7, wherein surfaces of the first and the second pluralities of light reflection features facing the reflective pixels are reflective, and surfaces of the first and the second pluralities of light reflection features facing forwards are visually black.

10. The system of claim 1, wherein a transparent buffer layer is disposed between the first plurality of light reflection features and the pixels.

11. The system of claim 10, wherein features of the first plurality of light reflection features are disposed in tunnels in the transparent buffer layer, the tunnels extending from spaces between the pixels forward to the features of the first plurality of light reflection features.

12. The system of claim 1, wherein the back light guide comprises an array of lenses shaped and located with respect to the light-injection apertures to direct light into the light-injection apertures.

13. The system of claim 12, wherein a reflective layer is disposed on the front side of the back light guide, wherein lenses of the array of lenses are aligned with openings in the reflective layer.

14. The system of claim 13, wherein the array of lenses are formed on the front side of the back light guide, the lenses disposed between portions of the reflective layer.

15. The system of claim 12, wherein lenses of the array of lenses have a concave shape and are rounded outwards of the back light guide.

16. The system of claim 12, wherein lenses of the array of lenses are formed in recesses in the back light guide, the recesses filled with a high refractive index transparent material.

17. The system of claim 1, wherein the back light guide is coated with a reflective layer on at least one of the front or back sides of the back light guide

18. The system of claim 17, wherein both the front and the back sides of the back light guide are coated with reflective layers.

19. The system of claim 1, further comprising angled reflective surfaces on at least one of the front or back sides of the back light guide.

20. The system of claim 1, wherein the at least one light source is disposed at a side of the back light guide or behind the back light guide.

21. The system of claim 1, wherein the array of reflective pixels comprises interferometric modulators.

22. The system of claim 1, wherein the array of reflective pixels comprises pixels selected from the group consisting of electrophoretic display pixels, electrowetting display pixels, reflective LCD pixels, super-twisted nematic display (STN) display pixels, and combinations thereof.

23. The system of claim 1, wherein the array of reflective pixels is spaced apart from the backlight.

24. The system of claim 1, further comprising:
a processor that is configured to communicate with the array of reflective pixels, the processor being configured to process image data; and
a memory device that is configured to communicate with the processor.

25. The system of claim 24, further comprising:
a driver circuit configured to send at least one signal to the array of reflective pixels.

26. The system of claim 25, further comprising:
a controller configured to send at least a portion of the image data to the driver circuit.

27. The system of claim 24, further comprising:
an image source module configured to send the image data to the processor.

28. The system of claim 27, wherein the image source module comprises at least one of a receiver, transceiver, and transmitter.

29. The system of claim 24, further comprising:
an input device configured to receive input data and to communicate the input data to the processor.

30. A display system, comprising:
an image formation means for reflecting incident light outward from a viewable side of the display system to form a displayed image; and
an illumination means for generating light behind elements of the displayed image and directing the light forward of elements of the displayed image and redirecting the light back towards the image formation means.

31. The system of claim 30, wherein the image formation means comprises a plurality of reflective pixels.

32. The system of claim 31, wherein the reflective pixels comprise interferometric modulators.

33. The system of claim 31, wherein the illumination means comprises:
a light source disposed behind the reflective pixels;
a light guide configured to eject light past the reflective pixels; and
a first plurality of light reflection features configured to reflect light ejected past the reflective pixels back towards the pixels.

34. The system of claim 33, further comprising a second plurality of light reflection features configured to reflect light propagating past the first plurality of light reflection features back towards the pixels.

35. The system of claim 33, further comprising a plurality of lenses shaped and located with respect to the pixels to eject light through openings between the pixels.

36. A method for making a display device, comprising:
providing an array of reflective pixels having a front side for displaying an image, wherein pixels of the array of reflective pixels are separated by light-injection apertures;
providing a backlight on a back side of the reflective pixels, the backlight configured to eject light through the light-injection apertures; and
providing a first plurality of light reflection features forward of the pixels, the light reflection features configured to reflect light, which has been ejected through the light-injection apertures, back towards the pixels.

37. The method of claim 36, wherein providing the backlight comprises attaching the backlight to a substrate supporting the array of reflective pixels.

38. The method of claim 36, further comprising providing a second plurality of light reflection features configured to reflect light propagating past the first plurality of light reflection features back towards the pixels, the second plurality of light reflection features provided forward of the first plurality of light reflection features.

39. The method of claim 36, wherein providing the backlight comprises providing a plurality of lenses shaped and located with respect to the pixels to eject light through openings between the pixels.
